(19) United States
(12) Patent Application Publication
(10) Pub. No.: US 2023/0224158 A1
(43) Pub. Date: Jul. 13, 2023

(54) SYSTEM AND METHOD FOR PROCESSING A BATTERY PASSPORT

(71) Applicant: World Economic Forum, Cologny (CH)

(72) Inventors: Jonathan ECKART, Geneve (CH); Stanislaus MATHY, Herndon, VA (US)

(21) Appl. No.: 17/574,224

(22) Filed: Jan. 12, 2022

(51) Int. Cl. H04L 9/32

(52) U.S. Cl. CPC H04L 9/32

(57) ABSTRACT

A system and method for processing a battery passport that include receiving battery related data associated with a battery. The system will therefore store battery related data associated with many batteries and also be able to capture aggregated data across all of these. The system and method also include determining a level of sustainability associated with the battery. The system and method further include processing the battery passport to include the battery related data and the level of sustainability associated with the battery and indeed the level of sustainability with all batteries that have a battery passport.

### BACKGROUND

With the advent of electric technology being used to power numerous vehicular and mechanical systems, batteries are being utilized on a larger scale than in the past. For example, electric vehicles are being manufactured and used on a larger scale that use electric batteries to power one or more systems. As battery technology is being more heavily utilized, sourcing, production, distribution, and/or utilization of batteries result in a larger social impact, environmental impact, and operational impact. However, there is currently little to no traceability, verifiability, and/or transparency with respect to the sourcing, production, distribution, utilization, disposal, recycling, and/or repurposing of batteries. As such, it cannot be verified whether one or more steps in a value chain lifecycle of particular batteries may be linked to negative environmental impacts (e.g., large carbon footprint, habitat devastation leading to species extinction), negative social impacts (e.g., human rights issues, poor labor practices), and/or negative operational impacts (e.g., battery usability issues, low battery life expectancy, harmful battery composition, battery component reusability/resale issues, high production costs, high recycling costs). In addition, the total environmental, social and governance footprint of the batter value chain—as opposed to any given individual battery—is currently not assessed. Consequently, it is also not possible to improve this performance across the full value chain towards outcomes that are socially desirable and in line with international targets (e.g. Paris Agreement).

While the data associated with one or more steps of the value chain lifecycle of the batteries may exist, such data may be held by respective value chain stakeholders (e.g., raw materials suppliers, supply chain stakeholders, battery manufacturers, vehicle manufacturers, vehicle/battery owners, materials disposal services). In other words, data pertaining to the sourcing, production, distribution, utilization, disposal, recycling, and/or repurposing of numerous batteries may be stored within respective information technology systems that are owned and/or operated by respective value chain stakeholders. Accordingly, respective knowledge may not be shared between value chain stakeholders associated with the batteries and/or with consumers within the marketplace.

There is no generally accepted designation that may be applied to batteries to allow the marketplace to determine which batteries are socially sustainable, environmentally sustainable, and/or operationally sustainable. Therefore, value chain stakeholders that are not directly involved in respective value chain steps of batteries may not be able to efficiently determine which batteries are sourced, produced, distributed, utilized, recycled, and/or repurposed in a sustainable manner which would enable the materials purchase, production, marketing, selling, and/or reconditioning of sustainable batteries as distinct and more valuable products in the market place.

### BRIEF DESCRIPTION

According to one aspect, a computer-implemented method for processing a battery passport that includes receiving battery related data associated with a battery. The battery related data includes information pertaining to a value chain of the battery and a lifecycle of the battery. The computer-implemented method also includes determining a level of sustainability associated with the battery. The level of sustainability pertains to at least one of: an environmental impact, a social impact, an operational impact, and a sourcing impact of the battery. The computer-implemented method further includes processing the battery passport to include the battery related data and the level of sustainability associated with the battery. The battery passport is configured as a digitally encrypted data packet that is passed through a secure storage medium technology to complete a secure communication of the battery related data to value chain stakeholders of the value chain of the battery. The secure storage medium technology can either be a cloud-based application technology, a blockchain technology or a database technology.

According to another aspect, a system for processing a battery passport that includes a computing infrastructure that includes a memory that stores instructions that are executed by a processor of the computing infrastructure that cause the processor to receive battery related data associated with a battery from a computing infrastructure associated with value chain stakeholders of a value chain of the battery and from electronic components of the battery. The instructions also cause the processor to determine a level of sustainability associated with the battery. The level of sustainability pertains to at least one of an environmental impact, a social impact, an operational impact, and a sourcing impact of the battery. The instructions further cause the processor to process the battery passport to include the battery related data and the level of sustainability associated with the battery. The battery passport is configured as a digitally encrypted data packet that is passed through computing systems of a blockchain infrastructure to complete a secure communication of the battery related data and the level of sustainability to the value chain stakeholders.

According to yet another aspect, a non-transitory computer readable storage medium storing instructions that when executed by a computer, which includes a processor perform a method that includes receiving battery related data associated with a battery. The battery related data includes information pertaining to a value chain of the battery and a lifecycle of the battery. The method also includes determining a level of sustainability associated with the battery. The level of sustainability pertains to at least one of: an environmental impact, a social impact, an operational impact, and a sourcing impact of the battery. The method further includes processing a battery passport to include the battery related data and the level of sustainability associated with the battery. The battery passport is configured as a digitally encrypted data packet that is passed through blockchain technology to complete a secure communication of the battery related data to value chain stakeholders of the value chain of the battery.

The ESG footprint performance is compiled across all batteries captured on the system so that the industry performance can be captured and evaluated with respect to the ESG dimension such as the GHG footprint of batteries produced. Importantly, this allows the performance tracking and improvement of this performance across the value chain towards goals set by a “policy consortium” (e.g. reduce total GHG footprint of the value chain by 50% by 2030).

The interoperability of the Battery Passport with other solutions can be enabled by establishing a common data framework with other solutions which are designed to report data into.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary operating environment for processing a battery passport that is associated with a battery according to an exemplary embodiment of the present disclosure;

FIG. 2 is a schematic overview of electrical components of the battery according to an exemplary embodiment of the present disclosure;

FIG. 3 is an exemplary schematic overview of a plurality of modules that may be configured to process and update the battery passport associated with the battery according to an exemplary embodiment of the present disclosure;

FIG. 4 is a process flow diagram of a method for characterizing battery related data and processing the battery passport according to an exemplary embodiment of the present disclosure;

FIG. 5 is a process flow diagram of a method for determining a level of sustainability associated with the battery and communicating the battery passport through blockchain technology according to an exemplary embodiment of the present disclosure; and

FIG. 6 is a process flow diagram of a method for processing a battery passport according to an exemplary embodiment of the present disclosure.

### DETAILED DESCRIPTION

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to transfer data between computer components within a singular or multiple system. The bus may be a memory bus, a memory controller, a peripheral bus, an external bus, a crossbar switch, and/or a local bus, among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “memory,” as used herein may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module,” as used herein, includes, but is not limited to, hardware, firmware, software in execution on a machine, and/or combinations of each to perform a function(s) or an action(s), and/or to cause a function or action from another module, method, and/or system. A module may include a software-controlled microprocessor, a discreet logic circuit, an analog circuit, a digital circuit, a programmed logic device, a memory device containing executing instructions, and so on.

An “operable connection,” as used herein may include a connection by which entities are “operably connected”, is one in which signals, physical communications, and/or logical communications may be sent and/or received. An operable connection may include a physical interface, a data interface and/or an electrical interface.

A “processor,” as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X” “slightly x”, “x,” “very x” and “extremely x”.

A “vehicle,” as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, personal watercraft, and aircraft. In some cases, a motor vehicle includes one or more engines.

Battery sustainability will include issues like corruption and other integrity-related questions and will also track data pertaining to the use phase of the battery (state of health of the battery, residual charge value etc.).

### I. System Overview

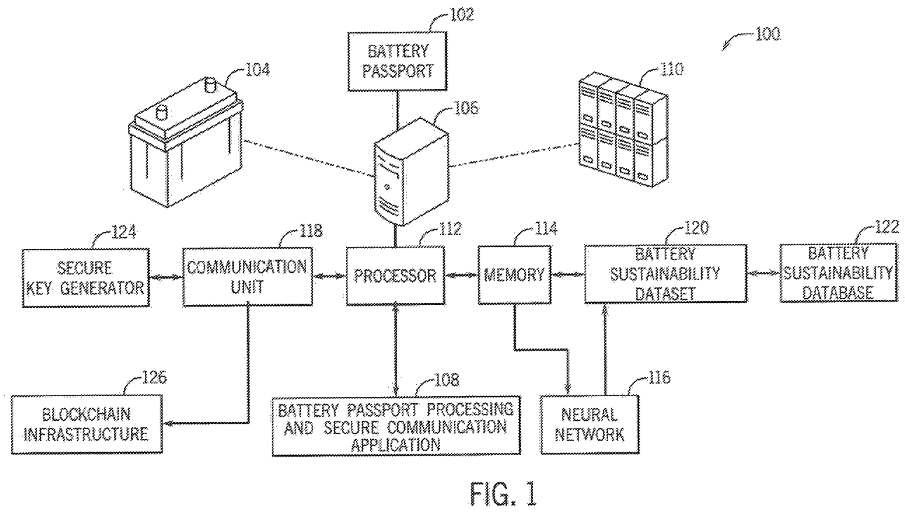

Referring now to the drawings, wherein the showings are for purposes of illustrating one or more exemplary embodiments and not for purposes of limiting the same, FIG. 1 is a schematic view of an exemplary operating environment 100 for processing a battery passport 102 that is associated with a battery 104 according to an exemplary embodiment of the present disclosure. In an exemplary embodiment, the operating environment 100 may include a secure server infrastructure (secure server) 106 that may be configured to execute a battery passport processing and secure communication application (battery passport application) 108 that may be configured to process and securely communicate the battery passport 102.

In an exemplary embodiment, the battery passport 102 may be configured as a digitally encrypted data packet (e.g., datafile) and may be specifically associated with the battery 104. The battery passport 102 may be configured as a digital representation of the battery 104 that may convey information about applicable environmental requirements, social requirements, governance requirements, and lifecycle requirements based on a comprehensive definition of a sustainable battery that may be defined by one or more global policy consortiums. The battery passport 102 may be recognized as a digital twin of the battery 104 that documents battery related information and sustainability information that is associated with the battery 104 along a value chain of the battery 104 from raw material mining until end of life of the battery 104 to disposal, recycling, or re-purposing (e.g., reconditioning and reentering the battery 104 to the value chain) of the battery 104 and/or or one or more components of the battery 104.

In one embodiment, the battery passport 102 may be processed and populated with sustainability information that pertains to the battery 104. The sustainability information may be based on sustainability standards that may be set by the one or more global policy consortiums to enable one or more value chain stakeholders that are involved in raw materials sourcing, materials production, manufacturing, marketing, sales, distribution, utilization, resale, repurposing, and/or disposal of the battery 104 and/or its components to determine if the battery 104 is sustainable. In particular, the battery passport 102 may enable one or more value chain stakeholders to determine if the battery 104 is socially sustainable, environmentally sustainable, and/or operationally sustainable.

The battery passport 102 may be analyzed by value chain stakeholders to determine if the battery 104 is sourced, produced, distributed, utilized, disposed, recycled, and/or repurposed in an environmentally sustainable manner (e.g., with a low carbon footprint), in a socially sustainable manner (e.g., with the use of legitimate labor practices), and in an operational sustainable manner (e.g., the battery 104 may be operationally and/or economically efficient, components may be repurposed or recycled). The battery passport 102 may provide transparency of social, environmental, and operational impacts which allow value chain stakeholders to determine compliance with social conscious, environmentally conscious, and/or operationally conscious globally accepted regulations, requirements, and/or policies. The sustainability level and additional battery related data included within the battery passport 102 may enable value chain stakeholders to have confidence in their investments and accountability with respect to the raw materials mining, materials purchase, production, marketing, selling, disposal, recycling and/or reconditioning of the battery 104 and/or components of the battery 104. As such, the battery passport 102 may function to provide market and investment confidence that may accelerate the demand for the battery 104 in the marketplace.

The battery passport 102 may additionally function to provide economic benefits for value chain stakeholders and within the marketplace. For example, the battery passport 102 may be evaluated by value chain stakeholders to implement battery cost reduction measures at one or more steps of the value chain process of the battery 104 and/or components of the battery 104. Additionally, manufacturers may realize higher residual values with respect to the repurposing of batteries based on an evaluation of battery related data included within the battery passport 102.

In an exemplary embodiment, the battery 104 may be configured as a rechargeable electric battery that may be designed in a variety of formats. The battery 104 may be configured in various form factors and to be utilized in various environments and/or use cases (e.g., electric vehicles, aircraft, watercraft, electrical generators, electronic devices, etc.). For example, the battery 104 may be configured in a particular shape to be placed under a floorboard of an electric vehicle (not shown) or within a particular customized compartment of an aircraft (not shown).

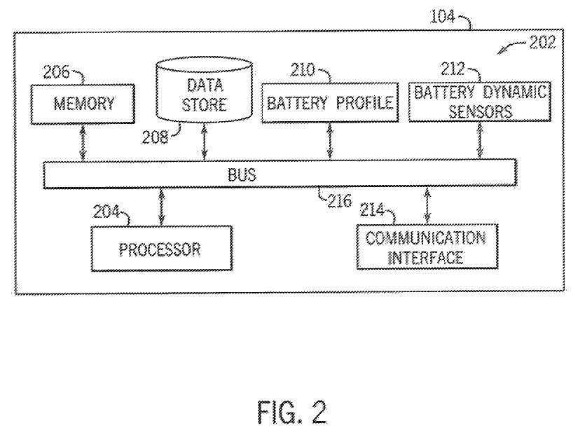

The battery 104 may be configured in different energy storage configurations that may include, but may not be limited to, Lithium Ion (Li-Ion), Molten Salt (Na—NICl2), Nickel Metal Hydride (Ni-MH), Lithium Sulphur (Li—S), lead-acid (“flooded”, deep-cycle, and valve regulated lead acid), nickel-cadmium (Ni—Cd), nickel-metal hydride, zinc-air, sodium nickel chloride, among others. In one embodiment, the battery 104 may include a plurality of electrical components (shown in FIG. 2) that may be configured to provide data to the battery passport 102, the secure server 106, a value chain computing infrastructure 110, and/or one or more external computing systems (not shown) that may be owned and/or operated by one or more value chain stakeholders.

As discussed below, the battery passport application 108 may be configured to receive battery related data that includes various types of information that may pertain to a value chain of the battery 104 and a lifecycle of the battery 104. The battery related data may be received by the battery passport application 108 based on communication to and from electronic components of the battery 104 and/or to and from the value chain computing infrastructure 110 that may be accessed and populated by various value chain stakeholders. The battery related data that may be received from the electronic components of the battery 104 and the value chain computing infrastructure 110 may be populated within the battery passport 102 that is processed by the battery passport application 108. The battery passport application 108 may additionally be configured to characterize the battery related data into particular battery related data characteristics and may utilize data that is provided by the one or more global policy consortiums to assign sustainability scoring data values to each of the particular battery related data characteristics.

As discussed in more detail below, the battery passport application 108 may further analyze the sustainability scoring data values and may thereby determine a level of sustainability that is associated with the battery 104. The level of sustainability may pertain to an environmental impact, a social impact, and/or an operational impact, associated with raw materials mining, materials purchase, production, marketing, selling, disposal, recycling, and/or reconditioning of the battery 104 and/or components of the battery 104. The level of sustainability may be populated upon the battery passport 102 to allow the value chain stakeholders to efficiently determine the level of sustainability that is associated with the sourcing, production, distribution, utilization, reconditioning, and/or disposal of the battery 104.

As discussed below, the battery passport application 108 may additionally be configured to facilitate a secure communication of the battery passport 102 to one or more value stakeholders through the use of block chain technology. The use of the block chain technology may allow the communication of the battery passport 102 to one or more value chain stakeholders in an encrypted and secure manner using blockchain. This functionality may allow value chain stakeholders to retrieve battery related data and the level of sustainability associated with the battery 104 in a secure manner and may prohibit data manipulation and/or tampering from unauthorized third parties.

With continued reference to FIG. 1, the secure server 106 may include a processor 112. The processor 112 may operably control one or more components of the secure server 106. In an exemplary embodiment, the processor 112 may be configured to execute the battery passport application 108. The processor 112 may be configured to execute one or more operating systems, secure system and subsystem executable instructions, and the like. The processor 112 may also include respective internal processing memory, an interface circuit, and bus lines for transferring data, sending commands, and communicating with the plurality of components of the secure server 106.

In one embodiment, the processor 112 may be operably connected to a memory 114 of the secure server 106. The memory 114 may be configured to store data files associated with one or more applications, operating systems, value chain systems, including but not limited to data files of the battery passport application 108. In one embodiment, the memory 114 may be configured to host a neural network 116. The neural network 116 may be operably controlled by the processor 112 to execute machine learning/deep learning processes to provide artificial intelligence capabilities that may be used to evaluate the battery related data of the battery 104.

In particular, the neural network 116 may be trained at one or more points in time with data that may be provided by the one or more global policy consortiums that may be used to characterize data points that are derived from the battery related data that may be received by the battery passport application 108 from the electronic components of the battery 104 and the value chain computing infrastructure 110. In one embodiment, the battery passport application 108 may utilize a communication unit 118 of the secure server 106 to communicate with one or more externally hosted computing systems (not shown) that may be owned, operated, and/or managed by one or more global policy consortiums to train the neural network 116 to characterize data points that are derived from the battery related data by updating a battery sustainability dataset 120 that may be stored upon the memory 114 of the secure server 106.

In an exemplary embodiment, the battery sustainability dataset 120 may be configured as a relational dataset that includes a plurality of fields that may be associated with various types of battery related data characteristics. The various types of battery related data characteristics may include, but may not be limited to, physical characteristics of the battery 104, societal characteristics of the battery 104, environmental characteristics of the battery 104, and health characteristics of the battery 104. The various types of battery data characteristics may be associated with various pre-trained data points that may allow the neural network 116 to analyze data points that are derived from the battery related data received by the battery passport application 108 in order to characterize the type of battery related data into one or more battery related data characteristics.

The battery sustainability dataset 120 may also be trained with a sustainability scoring system that may be used to score the characterized data points derived from the battery related data based on sustainability standards that may be determined by the one or more global policy consortiums. Such sustainability standards may be related to social standards that may pertain to labor practices, regulatory, and societal impacts of producing and/or using batteries and their components. Additionally, the sustainability standards may be related to environmental standards that may pertain to environmental, climate related, and/or recycling impacts of producing and/or using batteries and their components. The sustainability standards may also be related to operational standards that may pertain to the health, longevity, reliability, and ability to repurpose and/or recycle batteries and their components. As discussed below, upon characterizing the battery related data, the battery passport application 108 may be configured to utilize the neural network 116 to assign sustainability scoring data values to each of the particular battery related data characteristics that pertain to the battery 104.

In an exemplary embodiment, the battery passport application 108 may also utilize the neural network 116 to use machine learning/deep learning processes to compare each of the sustainability scoring data values against global sustainability threshold values to categorize the battery 104 into sustainability categorizations that are associated with each of the battery related data characteristics. The sustainability categorizations may include, but may not be limited to, a top performing categorization, an average performing categorization, and a below performing categorization. These categorizations may be applied to the physical characteristics of the battery 104, societal characteristics of the battery 104, environmental characteristics of the battery 104, and health characteristics of the battery 104 based on the comparison of the sustainability scoring data values assigned to each of the particular battery related data characteristics to pre-trained global sustainability threshold values that may pertain to each of the sustainability categorizations.

In an exemplary embodiment, the battery sustainability dataset 120 may additionally be pre-updated with the global sustainability threshold values at one or more points in time based on data that may be provided by the one or more global policy consortiums to train the neural network 116 to categorize the battery related data characteristics of the battery 104. In particular, the battery sustainability dataset 120 may also include a plurality of fields that may be associated with various types sustainability categorizations and respective sustainability threshold values that may respectively apply to each of the sustainability categorizations for each of the battery related data characteristics.

As discussed below, the battery passport application 108 may utilize the neural network 116 to compare the sustainability scoring data values assigned to each of the particular battery related data characteristics against the respective sustainability threshold values that may be pre-trained within the battery sustainability dataset 120 to thereby categorize the battery related data characteristics of the battery 104. The battery passport application 108 may be configured to assign a sustainability value (e.g., 1-3 value) to each of the sustainability categorizations that have been assigned to each of the particular battery related data characteristics. The battery passport application 108 may be configured to further aggregate the sustainability values that are assigned to each of the sustainability categorizations to output a level of sustainability associated with the battery 104 (e.g., an overall sustainability level) that pertains to the environmental impact, the social impact, and/or the operational impact associated with raw materials mining, materials purchase, production, marketing, selling, disposal, recycling and/or reconditioning of the battery 104 and/or the components of the battery 104. The battery passport application 108 may thereby update the level of sustainability associated with the battery 104 upon the battery passport 102 to allow the value chain stakeholders to determine if the battery 104 may be considered environmentally sustainable, socially sustainable, and/or operationally sustainable.

In an exemplary embodiment. the memory 114 of the secure server 106 may additionally be configured to store a battery sustainability database 122. The battery sustainability database 122 may be configured as a relational database that includes respective data records that are each associated with a plurality of batteries (not shown). The battery sustainability database 122 may be configured to include sustainability data that may be associated with a plurality of batteries that may be available within the marketplace. In one embodiment, the battery sustainability database 122 may be configured to allow value chain stakeholders to access the database 122 to determine one or more batteries of one or more particular configurations (e.g., form factors, sizes, types, electrical configurations, chemical configurations) that have been assigned respective levels of sustainability (e.g., by execution of the battery passport application 108). Accordingly, the battery sustainability database 122 may enable value chain stakeholders to determine specific batteries and/or components of specific batteries that may be available within the marketplace for purchase, resale, utilization, recycling, and/or reconditioning that may be determined as being environmentally sustainable, socially sustainable, and/or operationally sustainable.

In an exemplary embodiment, upon and processing sustainability levels that are specifically associated with the battery 104, the battery passport application 108 may be configured to access the battery sustainability database 122 and create a data record that may be associated with the battery 104. The data record may be updated with information that pertains to an identification of the battery 104, physical characteristics of the battery 104, and/or additional battery related data. Additionally, upon processing and determining the sustainability level that is associated with the battery 104 and populating the battery passport 102, the battery passport application 108 may be configured to populate the data record with the level of sustainability associated with the battery 104. Accordingly, value chain stakeholders may determine if the battery 104 is determined to be environmentally sustainable, socially sustainable, and/or operationally sustainable in comparison to a plurality of additional batteries that may be included within the battery sustainability database 122.

In one or more embodiments, the processor 112 of the secure server 106 may be operably connected to a secure key generator 124. The secure key generator 124 may be configured to generate a respective secure key to value chain stakeholders to authorize respective value chain stakeholders to access the battery passport 102 through a blockchain infrastructure 126. In particular, each respective secure key may be processed with a numerical/alpha-numerical encrypted key code (e.g., n digit alpha-numeric code) that may be configured to authenticate each respective value chain stakeholder to retrieve the battery passport 102 through the blockchain infrastructure 126. As such, each respective secure key may enable each respective value chain stakeholder to retrieve the battery passport 102 through the blockchain technology in a secure manner to ensure that the battery passport 102 may not be accessed by an unauthorized third party.

In one or more embodiments, the blockchain infrastructure 126 may be configured to include one or more externally hosted computing systems that may be owned, operated, and/or hosted by one or more blockchain technology providers. In one embodiment, upon processing and population of the battery passport 102 by the application 108, the battery passport application 108 may be configured to pass the respective secure key to the blockchain infrastructure 126 for each respective value chain stakeholder. Upon authentication of each respective value chain stakeholder, the battery passport application 108 may enable the respective value chain stakeholder to utilize a respective computing system (not shown) to retrieve the battery passport 102 through the blockchain technology to analyze the battery passport 102 and retrieve the battery related data and the level of sustainability associated with the battery 104.

In an exemplary embodiment, the battery passport application 108 may be configured to communicate with the blockchain infrastructure 126 through the communication unit 118 of the secure server 106. The communication unit 118 may include one or more network interface cards (not shown) that may be configured to connect to one or more computing systems through an internet cloud (not shown). Such computing systems may include, but may not be limited to, electronic components of the battery 104, the value chain computing infrastructure 110, one or more externally hosted computing systems that may be owned, operated, and/or managed by one or more value chain stakeholders and/or one or more externally hosted computing systems that may be owned, operated, and/or managed by one or more global policy consortiums. In one configuration, the battery passport application 108 may be configured to utilize the communication unit 118 to wirelessly communicate with the electronic components of the battery 104 and/or computing systems of the value chain computing infrastructure 110 to receive the battery related data that may pertain to the battery 104.

In an exemplary embodiment, the value chain computing infrastructure 110 may include a plurality of computing systems (e.g., server farm) that may be owned, operated, and/or maintained by one or more value chain stakeholders, regulatory bodies, manufacturers, supply chain stakeholders, and/or third-party institutions. In one embodiment, during each step of the value chain process that may be associated with the sourcing, production, distribution, utilization, disposal, recycling, and/or repurposing of the battery 104, one or more respective value chain stakeholders may provide and update respective battery related data to the value chain computing infrastructure 110.

As an illustrative example, value chain stakeholders such as raw materials miners, manufacturers, shipping agencies, governmental agencies, regulatory agencies, and the like that may be involved the value chain lifecycle of the battery 104 may update data associated with raw material mining of the battery 104, labor practices associated with raw materials mining and/or the production of the battery, carbon footprint data that may be associated with the production and (expected or real-time) utilization of the battery 104, physical specifications of the battery 104 (e.g., electrical/chemical composition, cell and pack level of the battery 104), a chain of custody of the battery 104 and/or components of the battery 104, shipping mechanisms utilized to ship the battery 104 and/or components of the battery 104, and the like.

Additional types of value chain stakeholders may also update data to the value chain computing infrastructure 110 that may pertain to, but may not be limited to import/export compliance information, supply chain stakeholder identification (e.g., manufacturers, shipping companies, exporters, importers, ports of call, component manufacturers, battery sellers, vehicle manufacturers, vehicle/battery owners, etc.), and/or materials reconditioning/recycling/disposal services that may be involved with the repurposing, recycling, and/or disposal of the battery 104 and/or one or more components of the battery 104.

In an exemplary embodiment, the battery passport application 108 may be configured to utilize the communication unit 118 to communicate with one or more computing systems of the value chain computing infrastructure 110 to receive battery related data that may be updated to the value chain computing infrastructure 110 by one or more value chain stakeholders along the value chain. As discussed, the battery passport 102 may be configured to further analyze the battery related data that may be received from the value chain computing infrastructure 110 and may utilize the neural network 116 to characterize the battery related data.

FIG. 2 is a schematic overview of the electrical components of the battery 104 according to an exemplary embodiment of the present disclosure. In an exemplary embodiment, the battery 104 may include a battery control unit 202. The battery control unit 202 may be configured to control electronic components of the battery 104 to allow the battery 104 to receive charging power, output electrical power to power one or more external components, provide health status updates, and/or output battery related data. In one configuration, the battery control unit 202 may include a processor 204, a memory 206, a data store 208, battery dynamic sensors 212, and a communication interface 214. The electronic components of the battery 104, including the battery control unit 202, may be operably connected for computer communication via a bus 216 (e.g., a Controller Area Network (CAN) or a Local Interconnect Network (UN) protocol bus) and/or other wired and wireless technologies.

In an exemplary embodiment, the data store 208 may be configured to store a battery profile 210 of the battery 104. The battery profile 210 may be configured to store data pertaining to the identification of the battery 104. The data pertaining to the identification of the battery 104 may include, but may not be limited to, a manufacturer of the battery 104, a model of the battery 104, an identification code (e.g. alpha-numeric code) associated with the battery 104, a serial number associated with the battery 104 and the like. In some embodiments, the battery profile 210 may also store data that may include one or more codes that pertain to the chemical composition of the battery 104. For example, the battery profile 210 may include a code that pertains to the chemical composition of the battery 104 that includes a lithium-ion battery energy source. Additionally, the battery profile 210 may also store data that may include one or more codes that may pertain to additional components (e.g., casing composition, cell and pack level, electrical circuit composition) of the battery 104.

In one embodiment, the processor 204 of the battery control unit 202 may be configured to operably control the battery dynamic sensors 212 of the battery 104. The battery dynamic sensors 212 may be configured to sense various dynamic parameters that may pertain to an overall performance of the battery 104 that may include sensing of a voltage performance, an impedance, a charging capacity, an average charge retention time, an average charging time, and the like of the battery 104. The various dynamic parameters sensed by the battery dynamic sensors 212 may also include sensing of a utilization of the battery 104 that may include sensing of an average charging cycle, an average state of charge, a history of use, a number of charge cycles, and the like. Additionally, the battery dynamic sensors 212 may sense a health status of the battery 104 that may include sensing of an overall health of the battery energy source, status updates associated with electronic components and/or chemical components of the battery 104, and a physical state of the battery 104.

In one or more embodiments, the battery passport application 108 may utilize the communication unit 118 to communicate with the communication interface 214 of the battery control unit 202 to receive battery related data that may include the data that is stored within the battery profile 210 and sensed data that may be output by the battery dynamic sensors 212. As discussed, the battery passport 102 may be configured to further analyze the battery related data that may be received from the electronic components of the battery 104 and may utilize the neural network 116 to characterize the battery related data.

### II. The Battery Passport Processing and Secure Communication Application and Related Methods

Components of the battery passport application 108 will now be described according to an exemplary embodiment and with reference to FIG. 1. In an exemplary embodiment, the battery passport application 108 may be stored on the memory 114 of the secure server 106 and may be executed by the processor 112 of the secure server 106. In another embodiment, the battery passport application 108 may be stored on the value chain computing infrastructure 110 and may be accessed by the communication unit 118 of the secure server 106 to be executed by the processor 112 of the secure server 106. In additional embodiments, the battery passport application 108 may be stored on one or more externally hosted computing systems that may be owned, operated, and/or managed by one or more global policy consortiums and may be accessed by the communication unit 118 of the secure server 106 to be executed by the processor 112 of the secure server 106.

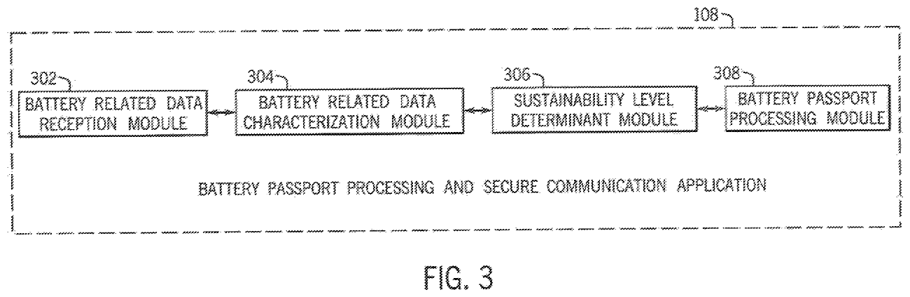

The general functionality of the battery passport application 108 will now be discussed. FIG. 3 is an exemplary schematic overview of a plurality of modules 302-308 that may be configured to process and update the battery passport 102 associated with the battery 104 according to an exemplary embodiment of the present disclosure. As shown in FIG. 3, the battery passport application 108 may include a battery related data reception module (data reception module) 302, a battery related data characterization module (data characterization module) 304, a sustainability level determinant module (sustainability determinant module) 306, and a battery passport processing module (passport processing module) 308. However, it is appreciated that the battery passport application 108 may include one or more additional modules and/or sub-modules that are included in lieu of or in addition to the modules 302-308.

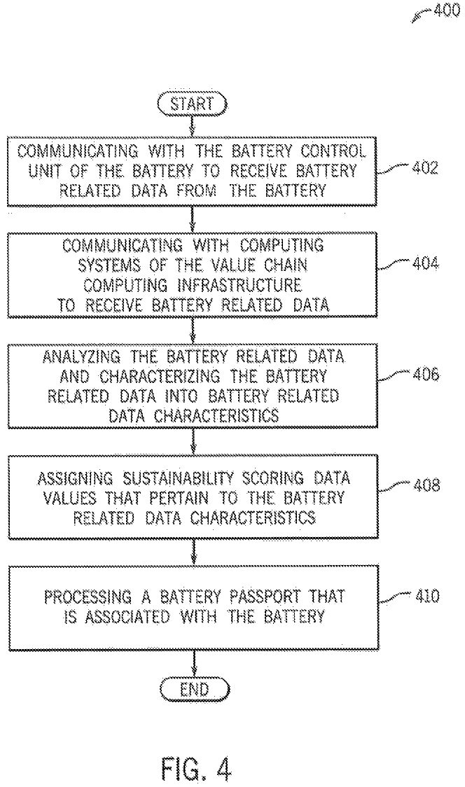

FIG. 4 is a process flow diagram of a method 400 for characterizing battery related data and processing the battery passport 102 according to an exemplary embodiment of the present disclosure. The method 400 of FIG. 4 will be described with reference to the components of FIG. 1, FIG. 2, and FIG. 3 though it is to be appreciated that the method 400 of FIG. 4 may be used with other systems/components. The method 400 may begin at block 402, wherein the method 400 may include communicating with the battery control unit 202 of the battery 104 to receive battery related data from the battery 104.

In an exemplary embodiment, the data reception module 302 of the battery passport application 108 may be configured to receive battery related data that may be further analyzed by the battery passport application 108. In particular, the data reception module 302 may be configured to utilize the communication unit 118 of the secure server 106 to communicate with the communication interface 214 of the battery control unit 202 to receive battery related data from the electronic components of the battery 104.

As discussed above, the battery related data may include sensed data that may be output by the battery dynamic sensors 212 of the battery 104. The sensed data may include various dynamic parameters that may pertain to an overall performance of the battery 104, a utilization of the battery 104, and/or a health status of the battery 104, and the like. The battery related data may also include data pertaining to the identification of the battery 104 that may be received from the battery profile 210 stored upon the data store 208 of the battery control unit 202. Such data may include a manufacturer of the battery 104, a model of the battery 104, an identification code associated with the battery 104, a serial number associated with the battery 104 and the like.

The method 400 may proceed to block 404, wherein the method 400 may include communicating with computing systems of the value chain computing infrastructure 110 to receive battery related data. In one embodiment, the data reception module 302 may be configured to utilize the communication unit 118 of the secure server 106 to communicate with communication systems (not shown) of the computing systems of the value chain computing infrastructure 110 to receive battery related data. As discussed above, during each step of the value chain process that may be associated with the sourcing, production, distribution, utilization, reconditioning, and/or disposal of the battery 104, one or more respective value chain stakeholders may provide and update respective battery related data to the value chain computing infrastructure 110. Such battery related data may pertain to raw materials mining, production of the battery 104, labor practices associated with the production of the battery 104 and/or components of the battery 104, carbon footprint data that may be associated with the production and (expected or real-time) utilization of the battery 104, physical specifications of the battery 104, and the like.

The method 400 may proceed to block 408, wherein the method 400 may include analyzing the battery related data and characterizing the battery related data into battery related data characteristics. In an exemplary embodiment, upon receiving the battery related data from the battery control unit 202 and the value chain computing infrastructure 110, the data reception module 302 may be configured to communicate the battery related data to the data characterization module 304 of the battery passport application 108. In one configuration, the data characterization module 304 may be configured to derive data points that may be associated with one or more types of battery related data that may be received from the battery control unit 202 and the value chain computing infrastructure 110. The data points may include particular dynamic parameters sensed by the battery dynamic sensors and particular types of data pertaining to the identification of the battery 104 received from the battery profile 210 of the battery control unit 202. The data points may also include particular types of data pertaining to each step of the value chain process received from the value chain computing infrastructure 110.

In an exemplary embodiment, upon deriving the data points that may be associated with one or more types of battery related data, the data characterization module 304 may communicate the data points to the neural network 116 to utilize the neural network 116 to analyze the data points of the battery related data of the battery 104. In one embodiment, upon receiving the data points of the battery related data from the data characterization module 304, the neural network 116 may be configured to execute machine learning/deep learning processes to characterize the battery related data into one or more respective battery related data characteristics.

As discussed above, the neural network 116 may be trained to characterize the data points that are derived from the battery related data based on updating of the battery sustainability dataset 120 by one or more global policy consortiums, in one configuration, the neural network 116 may analyze various types of battery data characteristics that may be associated with various pre-trained data points that are included within the battery sustainability dataset 120. The neural network 116 may thereby characterize the data points derived from the battery related data into the battery related data characteristics. Accordingly, the neural network 116 may characterize each of the data points derived from the battery related data into physical characteristics of the battery 104, societal characteristics of the battery 104, environmental characteristics of the battery 104, and/or health characteristics of the battery 104.

The method 400 may proceed to block 408, wherein the method 400 may include assigning sustainability scoring data values that pertain to the battery related data characteristics, in one embodiment, upon characterizing the each of the data points of the battery related data into the battery related data characteristics, the neural network 116 may execute machine learning/deep learning processes to analyze the data points against pre-trained sustainability scoring data to assign sustainability scoring data values to each of the battery related date characteristics. The neural network 116 may access the battery sustainability dataset to analyze the data points that have been characterized into respective battery related data characteristics to assign sustainability scoring data values respectively to each of the battery related data characteristics.

As discussed above, the battery sustainability dataset 120 may be trained with a sustainability scoring system that may be used to score the data points derived from the battery related data based on sustainability standards that may be determined by the one or more global policy consortiums. The neural network 116 may assign sustainability scoring data values to each of the physical characteristics of the battery 104, the societal characteristics of the battery 104, the environmental characteristics of the battery 104, and the health characteristics of the battery 104 based on analysis of the data points respectively characterized into each of the battery related data characteristics based on the trained data. Upon assigning sustainability scoring data values to each of the battery related data characteristics, the neural network 116 may communicate the assigned sustainability scoring data values and the associated battery related data characteristics to the data characterization module 304.

The method 400 may proceed to block 410, wherein the method 400 may include processing a battery passport 102 that is associated with the battery 104. In one embodiment, upon receiving the assigned sustainability scoring data values and the respective data points characterized by each particular battery related data characteristics, the data characterization module 304 may be configured to communicate the battery related data (e.g., data points), the battery related data characteristics, and the respective assigned sustainability scoring data values to the passport processing module 308 of the battery passport application 108.

In an exemplary embodiment, the passport processing module 308 may be configured to analyze the data points of the battery related data and may process the battery passport 102 that is associated with the battery 104. As discussed above, the battery passport 102 may be configured as a digitally encrypted data packet that may recognized as a digital twin of the battery 104. In one embodiment, upon processing the battery passport 102, the passport processing module 308 may be configured to update the battery passport 102 with identification information that identifies the battery 104.

The identification information may include information that has been received from the types of data pertaining to the identification of the battery 104 that has been received from the battery profile 210 of the battery control unit 202. For example, the passport processing module 308 may update the battery passport 102 with a manufacturer of the battery 104, a model of the battery 104, an identification code (e.g. alpha-numeric code) associated with the battery 104, a serial number associated with the battery 104 and the like. The passport processing module 308 may further update the battery passport 102 with the data points of the battery related data of the battery 104 to allow one or more value chain stakeholders to evaluate specific types of battery related data associated with the battery 104. In one embodiment, upon processing and updating the battery passport 102, the passport processing module 308 may access the memory 114 and may store the battery passport 102 upon the memory 114 to be updated further by the battery passport application 108.

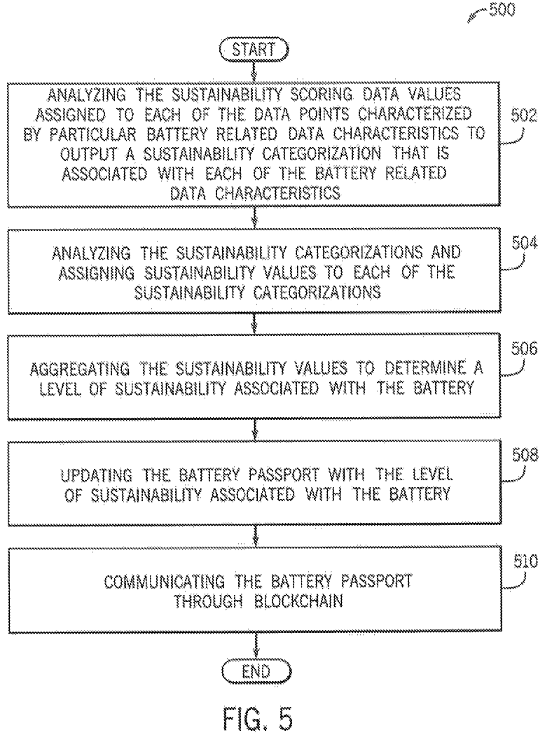

FIG. 5 is a process flow diagram of a method 500 for determining a level of sustainability associated with the battery 104 and communicating the battery passport 102 through the blockchain technology according to an exemplary embodiment of the present disclosure. The method 500 of FIG. 5 will be described with reference to the components of FIG. 1, FIG. 2, and FIG. 3 though it is to be appreciated that the method 500 of FIG. 5 may be used with other systems/components. The method 500 may begin at block 502, wherein the method 500 may include analyzing the sustainability scoring data values assigned to each of the data points characterized by particular battery related data characteristics to output a sustainability categorization that is associated with each of the battery related data characteristics.

In an exemplary embodiment, upon the assignment of the sustainability scoring data values to each of the data points characterized by particular battery related data characteristics, the data characterization module 304 may communicate data pertaining to the sustainability scoring data values that have been assigned to the sustainability determinant module 306 of the battery passport application 108. The sustainability determinant module 306 may be configured to communicate with the neural network 116 to analyze the sustainability scoring data values respectively assigned to each of the battery related data characteristics and output sustainability categorizations that are associated with each of the battery related data characteristics. As discussed above, the battery sustainability dataset 120 may be pre-updated with the global sustainability threshold values at one or more points in time by the one or more global policy consortiums.

In one configuration, the sustainability determinant module may utilize the neural network 116 to use machine learning/deep learning processes to compare each of the sustainability scoring data values against global sustainability threshold values to categorize the battery 104 into sustainability categorizations that apply to the battery related data characteristics of the battery 104. The neural network 116 may be configured to output sustainability categorizations that may include, but may not be limited to, a top performing categorization, an average performing categorization, and a below performing categorization to each of the battery related data characteristics. In particular, these categorizations may be applied to the physical characteristics of the battery 104, societal characteristics of the battery 104, environmental characteristics of the battery 104, and health characteristics of the battery 104 based on the comparison of the sustainability scoring data values assigned to each of the particular battery related data characteristics with pre-trained global sustainability threshold values that may pertain to each of the sustainability categorizations.

The method 500 may proceed to block 504, wherein the method 500 may include analyzing the sustainability categorizations and assigning sustainability values to each of the sustainability categorizations. In an exemplary embodiment, the neural network 116 may communicate the sustainability categorizations that apply to the physical characteristics of the battery 104, societal characteristics of the battery 104, environmental characteristics of the battery 104, and health characteristics of the battery 104 to the sustainability determinant module 306. The sustainability determinant module 306 may be configured to analyze each of the sustainability categorizations that apply to each of the battery related data characteristics and may assign a respective sustainability value that pertains to each of the sustainability categorizations.

In one configuration, the sustainability determinant module 306 may assign a high value (e.g., 3) to each of the battery related data characteristics that have been assigned a top performing categorization. The sustainability determinant module 306 may assign a moderate value (e.g., 2) to each of the battery related data characteristics that have been assigned an average performing categorization. Additionally, the sustainability determinant module 306 may assign a low value (e.g., 1) to each of the battery related data characteristics that have been assigned a below performing categorization.

The method 500 may proceed to block 506, wherein the method 500 may include aggregating the sustainability values to determine a level of sustainability associated with the battery 104. In an exemplary embodiment, upon assigning sustainability values to each of the sustainability categorizations assigned to respective battery related data characteristics, the sustainability determinant module 306 may be configured to aggregate the sustainability values assigned to each of the sustainability categorizations assigned to respective battery related data characteristics. Accordingly, the sustainability determinant module 306 may thereby output the level of sustainability associated with the battery 104. As discussed, the level of sustainability associated with the battery 104 pertains to the environmental impact, the social impact, and/or the operational impact (including manufacturing impact and also the impact of the battery use phase) associated with raw materials mining, materials purchase, production, marketing, selling, disposal, recycling and/or reconditioning of the battery 104 and/or the components of the battery 104.

In one embodiment, the sustainability determinant module 306 may further award a quality seal to the battery 104 if the aggregated sustainability value is above a quality seal threshold value. The quality seal threshold value may be a dynamic value that may indicate to one or more value chain stakeholders and/or consumers that the battery 104 surpasses acceptable requirements associated with raw materials mining, materials purchase, production, marketing, selling, disposal, recycling and/or reconditioning of the battery 104 and/or the components of the battery 104. For example, the quality seat may be utilized to indicate a high level of compliance with carbon emissions, human rights, and/or recycling standards that may be set forth by one or more regulatory bodies, one or more global policy consortiums, and/or one or more governments.

The method 500 may proceed to block 508, wherein the method 500 may include updating the battery passport 102 with the level of sustainability associated with the battery 104. In an exemplary embodiment, upon determining the level of sustainability, the sustainability determinant module 306 may be configured to communicate the level of sustainability associated with the battery 104 to the passport processing module 308. In circumstances in which the sustainability determinant module 306 has awarded a quality seal to the battery 104, the sustainability determinant module 308 may communicate data pertaining to the awarded quality seal to the passport processing module 308.

As discussed above (at block 410 of the method 400), upon processing the battery passport 102, the passport processing module 308 may store the battery passport 102 upon the memory 114. In one configuration, upon receiving the determined level of sustainability from the sustainability determinant module 306, the passport processing module 308 may retrieve the battery passport 102 from the memory 114. The passport processing module 308 may thereby update the battery passport 102 with the determined level of sustainability associated with the battery 104. If applicable, the passport processing module 308 may also update the battery passport 102 with an indication of the quality seal awarded to the battery 104.

In some embodiments, the passport processing module 308 may further communicate with the sustainability determinant module 306 to receive data pertaining to the sustainability categorizations and sustainability values associated with each of the battery related data characteristics and may further populate the battery passport 102 with respective data. This functionality may allow value chain stakeholders to determine a breakdown of the determined level of sustainability associated with the battery 104 to further determine specific battery related data characteristics that have been deemed more or less sustainable.

The method 500 may proceed to block 510, wherein the method 500 may include communicating the battery passport 102 through a cloud-based, blockchain or another IT system. In an exemplary embodiment, upon updating the battery passport 102 associated with the battery 104 with the level of sustainability associated with the battery 104, the passport processing module 308 may be configured to utilize the communication unit 118 of the secure server 106 to pass the battery passport 102 to the blockchain infrastructure 126. The blockchain infrastructure 126 may be configured to include one or more externally hosted computing systems that may be owned, operated, and/or hosted by one or more blockchain technology providers.

As discussed above, the battery passport application 108 may be configured to pass a respective secure key that may generated by the secure key generator 124 to be associated with each value chain stakeholder to the IT infrastructure 126 to authenticate each respective value chain stakeholder. Upon authentication of each respective value chain stakeholder, the battery passport application 108 may enable the respective value chain stakeholder to utilize a respective computing system to retrieve the battery passport 102 through the blockchain technology to analyze the battery passport 102 to retrieve battery related data of the battery 104 and the level of sustainability associated with the battery 104. In some circumstances, the battery passport 102 may be evaluated by one or more value chain stakeholders to determine a continued usage of the battery 104, a viability for repair of the battery 104, a viability for refurbishment of the battery 104, and the like.

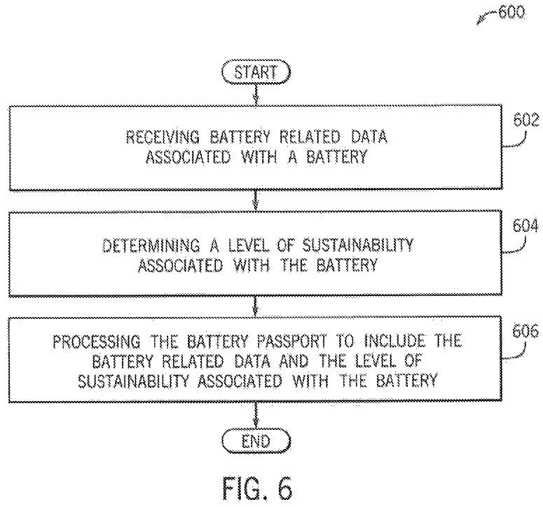

FIG. 6 is a process flow diagram of a method 600 for processing a battery passport 102 according to an exemplary embodiment of the present disclosure. The method 600 of FIG. 6 will be described with reference to the components of FIG. 1, FIG. 2, and FIG. 3 though it is to be appreciated that the method 600 of FIG. 6 may be used with other systems/components. The method 600 may begin at block 602, wherein the method 600 may include receiving battery related data associated with a battery 104. In one embodiment, the battery related data includes information pertaining to a value chain of the battery 104 and a lifecycle of the battery 104.

The method 600 may proceed to block 604, wherein the method 600 may include determining a level of sustainability associated with the battery 104. In one or more embodiments, the level of sustainability pertains to at least one of: an environmental impact, a social impact, and an operational impact of the battery 104. The method 600 may proceed to block 606, wherein the method 600 may include processing the battery passport 102 to include the battery related data and the level of sustainability associated with the battery 104. In one embodiment, the battery passport 102 is configured as a digitally encrypted data packet that is passed through secure cloud-based, blockchain or other IT technology to complete a secure communication of the battery related data to value chain stakeholders of the value chain of the battery 104.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for processing a battery passport comprising:
receiving battery related data associated with a battery, wherein the battery related data includes information pertaining to a value chain of the battery and a lifecycle of the battery;
determining a level of sustainability associated with the battery, wherein the level of sustainability pertains to at least one of: an environmental impact, a social impact, an operational impact, and a sourcing impact of the battery; and
processing the battery passport to include the battery related data and the level of sustainability associated with the battery, wherein the battery passport is configured as a digitally encrypted data packet that is passed through a secure storage medium technology to complete a secure communication of the battery related data to value chain stakeholders of the value chain of the battery.

2. The computer-implemented method of claim 1, wherein the secure storage medium technology is either a cloud-based application technology, a blockchain technology or a database technology.

3. The computer-implemented method of claim 1, wherein receiving the battery related data associated with the battery includes communicating with a central data repository associated with the value chain stakeholders to receive battery related data that is associated with at least one of: raw material mining of components of the battery, production of the battery, physical specifications of the battery, a supply chain of the battery, a chain of custody of the battery, and a repurposing of the battery upon an end of a life cycle of the battery.

4. The computer-implemented method of claim 1, wherein receiving the battery related data associated with the battery includes communicating with electronic components of the battery to receive battery related data that is associated with at least one of: an identification of the battery, an operation of the battery, a performance of the battery, a utilization of the battery, and a health status of the battery.

5. The computer-implemented method of claim 1, further including characterizing the battery related data into battery related data characteristics, wherein the battery related data characteristics include physical characteristics of the battery, societal characteristics of the battery, environmental characteristics of the battery, and health characteristics of the battery.

6. The computer-implemented method of claim 5, wherein data points of the battery related data that are characterized into the battery related data characteristics are updated to the battery passport.

7. The computer-implemented method of claim 6, wherein determining the level of sustainability includes assigning sustainability scoring data values to each of the battery related data characteristics of the battery and comparing the sustainably scoring data values assigned to each of the battery related data characteristics to sustainability threshold values to categorize the battery related data into sustainability categorizations that are associated with each of the battery related data characteristics.

8. The computer-implemented method of claim 7, wherein the sustainability categorizations associated with each of the battery related data characteristics include a top performing categorization, an average performing categorization, and a below performing categorization.

9. The computer-implemented method of claim 8, wherein sustainability values are assigned to each of the sustainability categorizations and the assigned sustainability values are aggregated to determine the level of sustainability associated with the battery, wherein the level of sustainability associated with the battery is utilized to determine the environmental impact, the social impact, and the operational impact of the battery.

10. A system for processing a battery passport comprising:
a computing infrastructure that includes a memory that stores instructions that are executed by a processor of the computing infrastructure, the instructions executed by the processor cause the processor to:
receive battery related data associated with a battery from a computing infrastructure associated with value chain stakeholders of a value chain of the battery and from electronic components of the battery;
determine a level of sustainability associated with the battery, wherein the level of sustainability pertains to at least one of: an environmental impact, a social impact, an operational impact, and a sourcing impact of the battery; and
process the battery passport to include the battery related data and the level of sustainability associated with the battery, wherein the battery passport is configured as a digitally encrypted data packet that is passed through computing systems of an infrastructure, preferably a blockchain infrastructure to complete a secure communication of the battery related data and the level of sustainability to the value chain stakeholders.

11. The system of claim 10, wherein the processor communicates with a central data repository associated with the value chain stakeholders to receive battery related data that is associated with at least one of: raw material mining of components of the battery, production of the battery, physical specifications of the battery, a supply chain of the battery, a chain of custody of the battery, and a repurposing of the battery upon an end of a life cycle of the battery.

12. The system of claim 10, wherein the processor communicates with the electronic components of the battery to receive battery related data that is associated with at least one of: an identification of the battery, an operation of the battery, a performance of the battery, a utilization of the battery, and a health status of the battery.

13. The system of claim 10, wherein a neural network operably controlled by the processor analyzes the battery related data and classifies the battery related data into battery related characteristics, wherein the battery related data characteristics include physical characteristics of the battery, societal characteristics of the battery, environmental characteristics of the battery, and health characteristics of the battery.

14. The system of claim 13, wherein the processor accesses the battery passport and updates data points of the battery related data that are classified into the battery related data characteristics to the battery passport.

15. The system of claim 13, wherein the neural network assigns sustainability scoring data values to each of the battery related data characteristics of the battery and compares the sustainably scoring data values assigned to each of the battery related data characteristics to sustainability threshold values to categorize the battery related data into sustainability categorizations that are associated with each of the battery related data characteristics.

16. The system of claim 15, wherein the sustainability categorizations associated with each of the battery related data characteristics include a top performing categorization, an average performing categorization, and a below performing categorization.

17. The system of claim 16, wherein the neural network assigns sustainability values to each of the sustainability categorizations and aggregates the sustainability values to determine the level of sustainability associated with the battery, wherein the level of sustainability associated with the battery is utilized to determine the environmental impact, the social impact, and the operational impact, of the battery.

18. The system of claim 17, wherein the environmental, social, operational impact of each battery is then aggregated to produce aggregate values for the environmental, social, operational, governance and lifecycle impact of the battery across the industry.

19. The system of claim 17, further including a battery sustainability database that includes database records that are associated with a plurality of batteries, wherein the processor is configured to access the battery sustainability database and populate a database record associated with the battery with the level of sustainability associated with the battery.

20. The system of claim 1, wherein the ESG footprint performance is compiled across all batteries captured on the system so that the industry performance can be captured and evaluated with respect to the ESG dimension such as the GHG footprint of batteries produced.

21. A non-transitory computer readable storage medium storing instruction that when executed by a computer, which includes a processor perform a method, the method comprising:
receiving battery related data associated with a battery, wherein the battery related data includes information pertaining to a value chain of the battery and a lifecycle of the battery;
determining a level of sustainability associated with the battery, wherein the level of sustainability pertains to at least one of: an environmental impact, a social impact, an operation al impact, and a sourcing impact of the battery; and
processing a battery passport to include the battery related data and the level of sustainability associated with the battery, wherein the battery passport is configured as a digitally encrypted data packet that is passed through a secured storage medium technology, in particular a cloud-based application technology, a blockchain technology or a database technology, to complete a secure communication of the battery related data to value chain stakeholders of the value chain of the battery.

22. The non-transitory computer readable storage medium of claim 21, further including characterizing the battery related data into battery related data characteristics, wherein the battery related data characteristics include physical characteristics of the battery, societal characteristics of the battery, environmental characteristics of the battery, and health characteristics of the battery.

23. The non-transitory computer readable storage medium of claim 22, wherein determining the level of sustainability includes assigning sustainability scoring data values to each of the battery related data characteristics of the battery and comparing the sustainably scoring data values assigned to each of the battery related data characteristics to sustainability threshold values to categorize the battery related data into sustainability categorizations that are associated with each of the battery related data characteristics.
